(19) United States
(12) Patent Application Publication
(10) Pub. No.: US 2015/0310101 A1
(43) Pub. Date: Oct. 29, 2015

(54) MATCHING INTERESTS OF USERS

(71) Applicant: Oz Labs Ltd., Maccabim (IL)

(72) Inventor: Ran Oz, Maccabim (IL)

(73) Assignee: Oz Labs Ltd., Maccabim (IL)

(21) Appl. No.: 14/259,201

(22) Filed: Apr. 23, 2014

(51) Int. Cl. G06F 17/30

(52) U.S. Cl. CPC G06F 17/30864

(57) ABSTRACT

A method for matching between interests of different users, the method may include obtaining, by a computerized service and from a group of users, users metadata that comprises users interest information and users contact information; wherein the obtaining of the users metadata involves an interaction between each user of the group of users and the computerized service; finding, in response to the users metadata, a sub-group of users that have a matching interest and are contacted to an intermediate person; wherein the finding of the sub-group of users is executed without receiving an input from the intermediate person; and responding to the finding of the sub-groups of users.

### BACKGROUND OF THE INVENTION

In various transactions a certain benefit may be gained if the parties of the transactions are linked to the same intermediate person. In many cases, the parties are not aware of the intermediate person and usually the connection between the parties requires the intermediate person to introduce the parties to each other. This may be a time and effort consuming process, especially when the intermediate person is linked to large number of persons.

There is a growing need to provide an automated method for linking parties that will not require an interaction with the intermediate person.

### SUMMARY

According to an embodiment of the invention there may be provided a method for matching between interests of different users, the method may include obtaining, by a computerized service and from a group of users, users metadata that may include users interest information and users contact information; wherein the obtaining of the users metadata involves an interaction between each user of the group of users and the computerized service; finding, in response to the users metadata, a sub-group of users that have a matching interest and are contacted to an intermediate person; wherein the finding of the sub-group of users is executed without receiving an input from the intermediate person; and responding to the finding of the sub-groups of users.

There may be provided a non-transitory computer readable medium that stores instructions that once executed by the computer cause the computer to execute the stages of obtaining, by a computerized system and from a group of users that are registered to a computerized service, users metadata that may include users interest information and users contact information; processing the users metadata to find a sub-groups of users that have a matching interest and are contacted to an intermediate person that is not registered to the computerized service; and responding to the finding of the sub-groups of users.

The intermediate person may not be registered to the computerized service.

The intermediate person may not belong to the group of users.

The responding to the finding of the sub-groups of users may not involve any interaction with the intermediate person.

The obtaining of the users metadata may include providing to the computerized service and by each user of the group of users at least a portion of a user metadata associated with the user.

The responding to the finding of the sub-groups of users may include sending to the sub-group of users a matching indication.

The method may include preventing from sending the intermediate person the matching indication.

The method may include sending the intermediate person the matching indication.

The processing of the user metadata may include correlating between user contact information of different formats.

The processing of the user metadata may include generating user profiles of users listed in the users contact information; wherein a generation of a user profile may include accumulating user contact information from different formats of user contact information.

The processing of the user metadata may include generating user profiles of users listed in the users contact information; wherein a generation of a user profile may include fetching user contact information that may be not included in the users contact information.

The obtaining of the users contact information may include retrieving users contact information from social networks and electronic mail services of the users.

The obtaining of the users metadata may include displaying to the users forms and receiving from the users inputs to the forms.

The method further may include generating the forms.

The method further may include receiving the forms.

The method further may include retrieving intermediate person metadata; and finding the sub-group of users only if the person is relevant to the matching interest.

According to an embodiment of the invention there is provided a method for matching between interests of different users, the method comprises: obtaining, by a computerized system and from a group of users that are registered to a computerized service, users metadata that may include users interest information and users contact information; finding, in response to the users metadata, a sub-group of users that have a matching interest and are contacted to an intermediate person that is not registered to the computerized service; and responding to the finding of the sub-groups of users.

According to an embodiment of the invention there is provided a method for matching between interests of different users, the method comprises: obtaining, by a computerized system and from a group of users that are registered to a computerized service, users metadata that may include users interest information and users contact information; finding, in response to the users metadata, a sub-group of users that have a matching interest and are contacted to an intermediate person that is not registered to the computerized service and is relevant to the matching interest; and responding to the finding of the sub-groups of users.

According to an embodiment of the invention there is provided a non-transitory computer readable medium that stores instructions that once executed by the computer cause the computer to execute the stages of obtaining, by a computerized system and from a group of users that are registered to a computerized service, users metadata that may include users interest information and users contact information; finding, in response to the users metadata, a sub-group of users that have a matching interest and are contacted to an intermediate person that is not registered to the computerized service and is relevant to the matching interest; and responding to the finding of the sub-groups of users.

According to an embodiment of the invention there is provided a non-transitory computer readable medium that stores instructions that once executed by the computer cause the computer to execute the stages of obtaining, by a computerized system and from a group of users that are registered to a computerized service, users metadata that may include users interest information and users contact information; finding, in response to the users metadata, a sub-group of users that have a matching interest and are contacted to an intermediate person that is not registered to the computerized service; and responding to the finding of the sub-groups of users

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 illustrates a method according to an embodiment of the invention;

FIG. 2 illustrates users metadata, users devices, network and a computerized system according to an embodiment of the invention;

FIG. 3 illustrates users metadata, users devices, network and a computerized system according to another embodiment of the invention;

FIG. 4 illustrates various forms according to various embodiments of the invention;

FIG. 5 illustrates metadata of a sub-group of users according to an embodiment of the invention;

FIG. 6 illustrates metadata of a sub-group of users according to an embodiment of the invention;

FIG. 7 illustrates a method according to an embodiment of the invention; and

FIG. 8 illustrates metadata of a sub-group of users according to an embodiment of the invention.

### DETAILED DESCRIPTION OF THE DRAWINGS

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

Because the illustrated embodiments of the present invention may for the most part, be implemented using electronic components and circuits known to those skilled in the art, details will not be explained in any greater extent than that considered necessary as illustrated above, for the understanding and appreciation of the underlying concepts of the present invention and in order not to obfuscate or distract from the teachings of the present invention.

Any reference in the specification to a method should be applied mutatis mutandis to a system capable of executing the method and should be applied mutatis mutandis to a non-transitory computer readable medium that stores instructions that once executed by a computer result in the execution of the method.

Any reference in the specification to a system should be applied mutatis mutandis to a method that may be executed by the system and should be applied mutatis mutandis to a non-transitory computer readable medium that stores instructions that may be executed by the system.

Any reference in the specification to a non-transitory computer readable medium should be applied mutatis mutandis to a system capable of executing the instructions stored in the non-transitory computer readable medium and should be applied mutatis mutandis to method that may be executed by a computer that reads the instructions stored in the non-transitory computer readable medium.

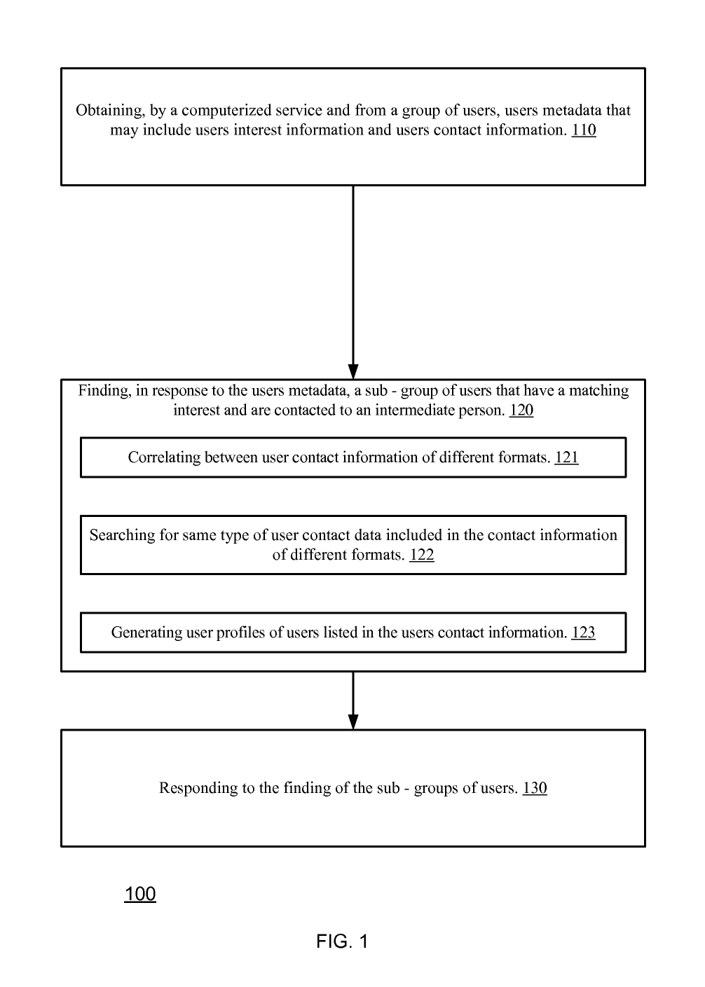

FIG. 1 illustrates method 100 according to an embodiment of the invention.

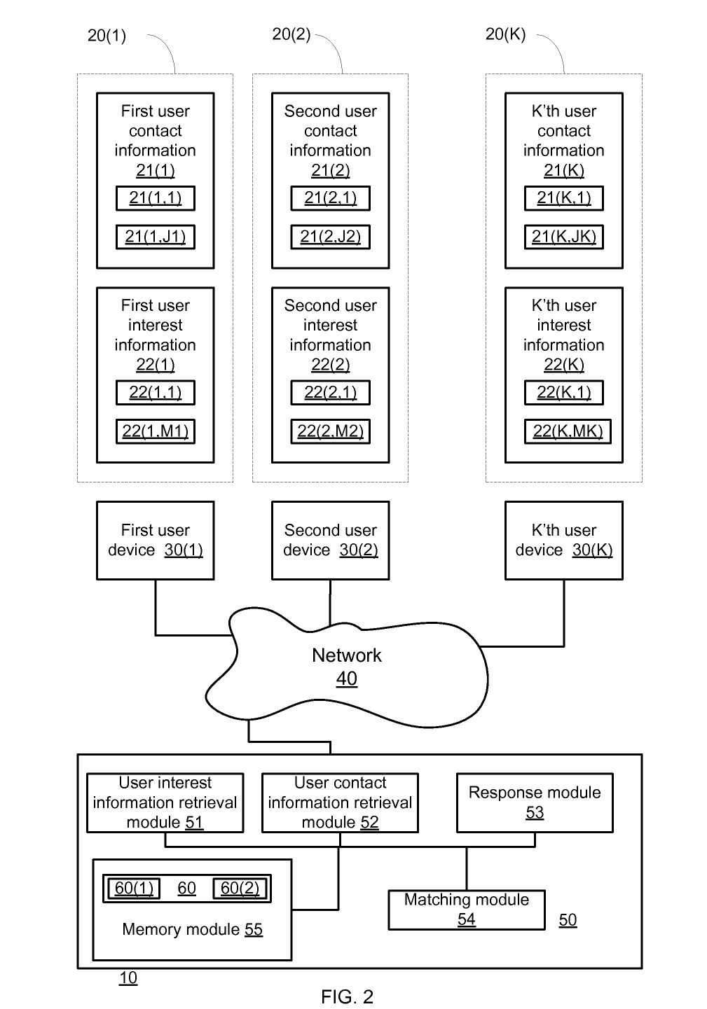

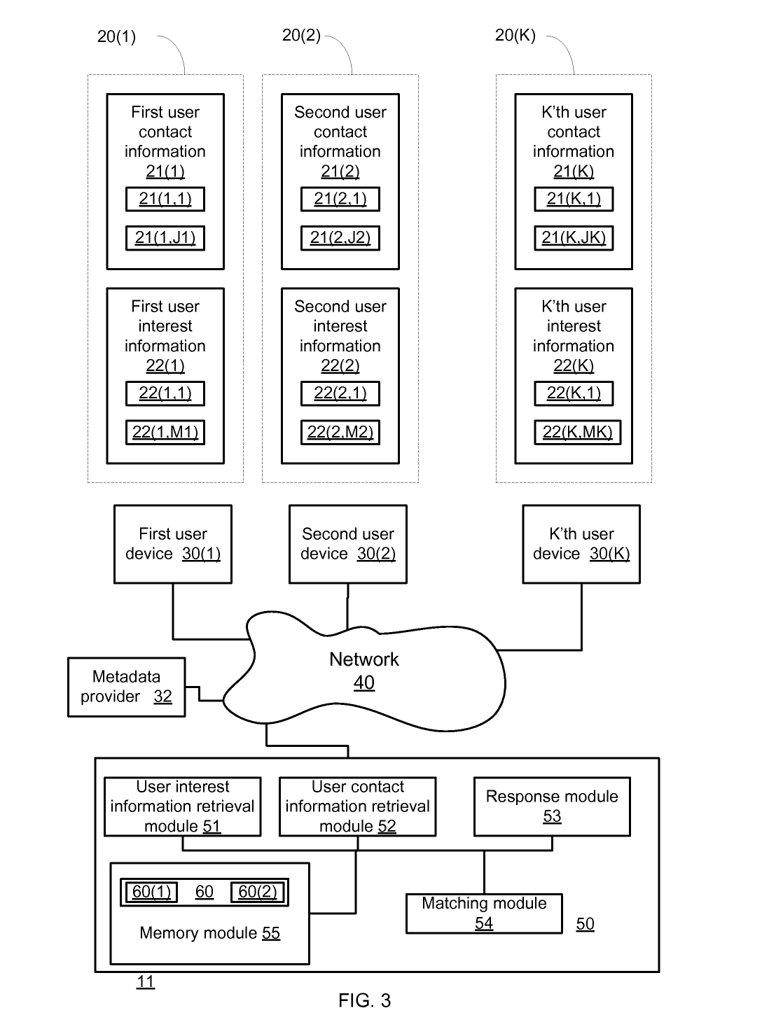

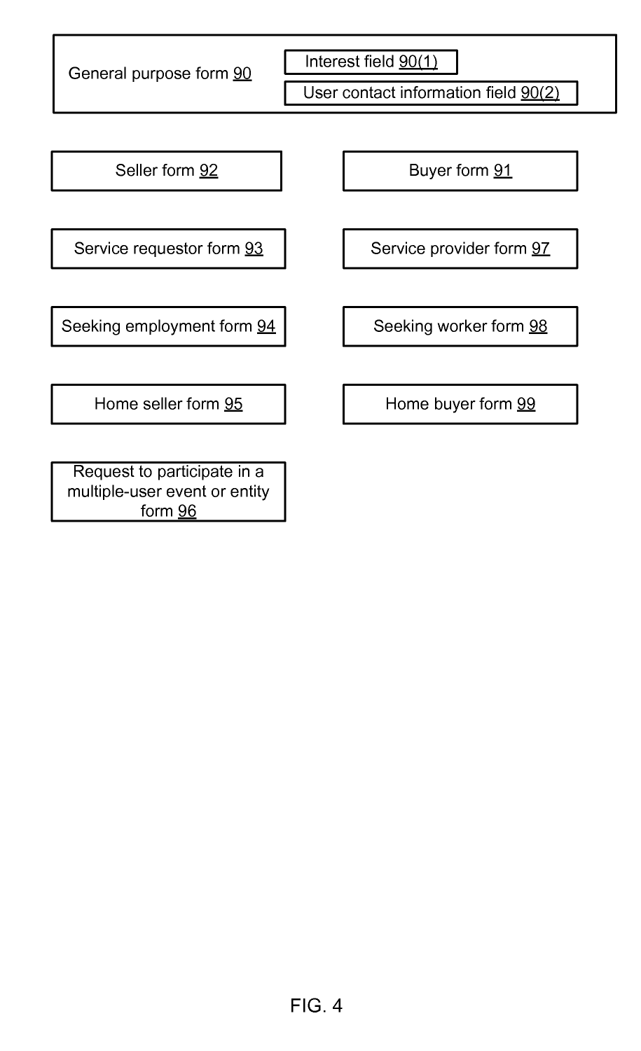

FIG. 2 illustrates users metadata 20(1), 20(2) and 20(K), users devices 30(1), 30(2) and 30(K), network 40 and a computerized system 50 according to an embodiment of the invention. FIG. 3 illustrates users metadata 20(1), 20(2) and 20(K), users devices 30(1), 30(2) and 30(K), network 40, metadata provider 32 and a computerized system 50 according to an embodiment of the invention. FIG. 4 illustrates various forms 90-99 according to various embodiments of the invention.

Referring to FIG. 1—method 100 may start by stage 110 of obtaining, by a computerized service and from a group of users, users metadata that may include users interest information and users contact information. The group of users may include multiple users. These users may be registered to the computerized service or be users that interacted with the computerized service. The computerized service is executed by a computerized system and/or by a user device. The computerized system and the user device may include one or more computers, one or more processors, and the like.

User contact information of a user may include contact information for contacting the user and contact information that allows the user to contact other persons. It may include phone numbers, facsimile numbers, electronic mail addresses, user device identifiers, social network contact information, enterprise identifier of the user, and the like. Non-limiting examples of contact information formats are a Linkedin™ profile, a Facebook™ profile, Skype™ contact information, Twitter™ contact information and the like. Different persons may be associated with different formats of contact information.

Non-limiting examples of users metadata are provided in FIGS. 2 and 3.

User metadata of first till K'th users (K being a positive integer that may exceed 1) is shown in FIGS. 2 and 3.

First user metadata 20(1) of a first user includes first user contact information 21(1) and first user interest information 22(1). The first user contact information 21(1) may include contact information 21(1,1)-21(1,J1) related to J1 persons (J1 being a positive integer). The first user interest information 22(1) may include interest information 22(1,1)-22(1,M1) related to M1 interests of the user (M1 being a positive integer).

Second user metadata 20(2) of a second user includes second user contact information 21(2) and second user interest information 22(2). The second user contact information 21(2) may include contact information 21(2,1)-21(2,J2) related to J2 persons (J2 being a positive integer). The second user interest information 22(2) may include interest information 22(2,1)-22(2,M2) related to M2 interests of the user (M2 being a positive integer).

K'th user metadata 20(K) of a K'th user includes K'th user contact information 21(K) and K'th user interest information 22(K). The K'th user contact information 21(K) may include contact information 21(K,1)-21(K,JK) related to JK persons (JK being a positive integer). The K'th user interest information 22(K) may include interest information 22(K,1)-22(K,MK) related to MK interests of the user (MK being a positive integer).

The first, second till K'th users metadata may be stored at first, second till K'th user devices 30(1)-30(K) that are coupled to the computerized system 50 via network 40. It is noted that users metadata may be stored in additional and/or other entities such as in cache memories, storage systems, servers and the like. User device may be mobile and/or portable and/or stationary devices including computers, game consoles, mobile phones, and the like. Users metadata and/or intermediate person metadata may be provided by a metadata provider 32 of FIG. 3.

An example of a metadata provider includes, for example, databases such as freebase and DBPedia that can help to gather more info on a name (like his twitter or facebook account).

According to an embodiment of the invention the computerized system 50 may be arranged to collect user metadata about the same person from different users. For example user A knows user B thru LinkedIn and has his email and cell number. User C knows user B from their facebook connection (provide only email of user B). User D knows user B only by cell phone (from his contacts list). The compouterized system will learn user B metadata from all the connections and will also conclude that user C and user D are connected thru user B, although user C only knows user B's email and user D only knows user B's cell phone. This is is an example of an intermediate user that is virtually linked to other users in a direct and inderect manner.

Referring back to FIG. 1—the obtaining (110) of the users metadata involves an interaction between each user of the group of users and the computerized service.

Stage 110 may include at least one of the following:
a. Retrieving users contact information from social networks and/or communication services of the users.
b. Obtaining of the users metadata may include displaying to the users forms and receiving from the users inputs to the forms.
c. Providing to the computerized service and by each user of the group of users at least a portion of a user metadata associated with the user. The user can be presented with a form and he may be requested to fill in at least a portion of his user metadata. The retrieval of users contact information may be done by the computerized service after obtaining the approval of the user

FIG. 4 provides an example of various forms 90-99 according to embodiments of the invention. Forms may be provided with different coverage areas.

There may be provided general purpose forms in which the user should provide his interest (see general purpose form 101 that includes one or more interest fields 101(1) and one or more user contact information field 101(2) for contacting the user).

There may be more specific forms that may be dedicated to obtaining services (service requestor form 103 and service provider form 97), purchasing of items (seller form 92, buyer form 91), joining multiple user events (multi-user event participation form 106) and the like.

There may be more specific forms that are tailored to specific fields of items (for example purchasing a car, a house), specific fields of services (seeking employment form 94 and seeking worker form 98), and the like. The forms may be specific to sub-fields of items (for example—purchasing Ford vehicles) or services and/or dedicated to specific services and/or items (for example—purchasing and/or selling a Toyota Corolla).

The user may be requested to provide additional information such as geographical limitations (or any other information that may be relevant to the service, item or event)—either in the forms or during later stages of the purchase process.

Stage 110 may be preceded by generating or receiving (not shown) the forms.

A form may include any arrangement of data. The form may be presented to a user by any audio and/or visual and/or contact based manner and the user may fill in data using any audio and/or visual and/or contact based manner.

Stage 110 may be followed by stage 120 of finding, in response to the users metadata, a sub-group of users that have a matching interest and are contacted to an intermediate person. The number of user per sub-group of users may be two or may exceed two. A user may be a member of one or more sub-groups of users.

The intermediate person may fulfill at least one of the following:
a. The intermediate person is not registered to the computerized service.
b. The intermediate person did not provide information to the computerized service.
c. The intermediate person does not belong to the group of users.
d. The intermediate person did not interact with computerized service (a) in the past, (b) during certain time windows, (c) during the execution of method 100, or (d) during the execution of one or more stages of method 100.

Alternatively, the intermediate person may belong to the group of users and may be registered to the computerized service. It is noted that under an embodiment of the invention the method 100 can be executed without requiring the intermediate person to be registered to the computerized service. Stage 120 may include at least one of the following:
a. Correlating (122) between user contact information of different formats. For example, a certain person may be contacted in different manners (via different social networks and/or different communication services). Certain users may store, for the certain person, contact information of different formats and stage 120 may include bridging the gaps between different contact information formats related to the same person. For example—a first user may store a LinkedIn™ profile of a certain person while another user may store only the cellular phone number of that certain person. Stage 122 may include determining that these two formats of contact information represent the same person.
b. Searching (121) for same type of user contact data included in the contact information of different formats. It is noted that this search may be futile if there is not any common user contact data and in this case stage 121 may include requesting from third parties to search for additional user contact data that will allow the correlation between the different formats. For example—if a third party may provide a cellular phone number and/or the email address or any other missing user contact data that is not included in both formats of the user contact information then the provision of that missing user contact data can assist in correlating between persons that may be contacted by different users
c. Generating (123) user profiles of users listed in the users contact information. A user profile may include information retrieved from one or more user contact information—even if the user contact information of different users are of different formats.

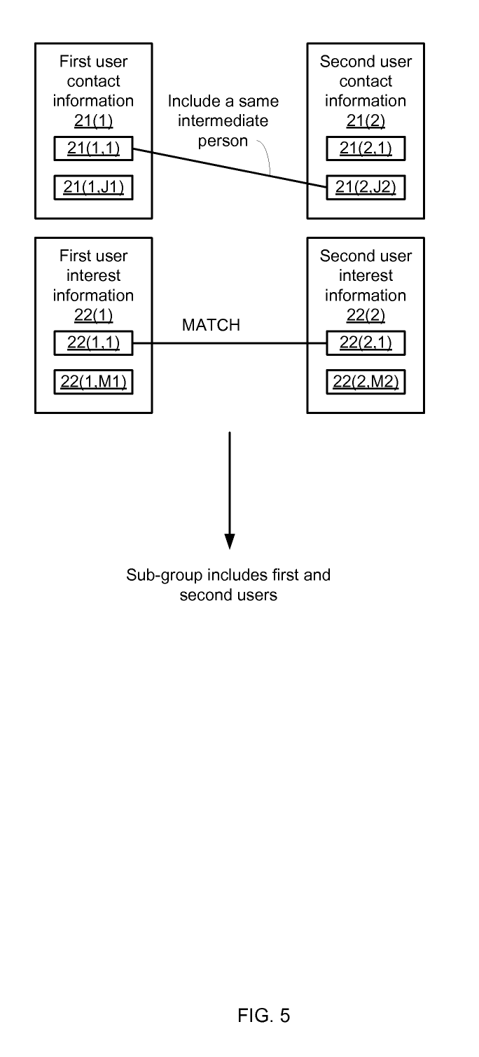

FIG. 5 illustrates metadata 20(1) and 20(2) of a sub-group of users according to an embodiment of the invention. First and second users are included in the sub-group because they are connected to the same intermediate person (represented by contact information 21(1,1) of first user and by content information 21(2,J2) of second user) AND have matching interests (interests are represented by interest information 22(1,1) of first user and 22(2,2) of second user).

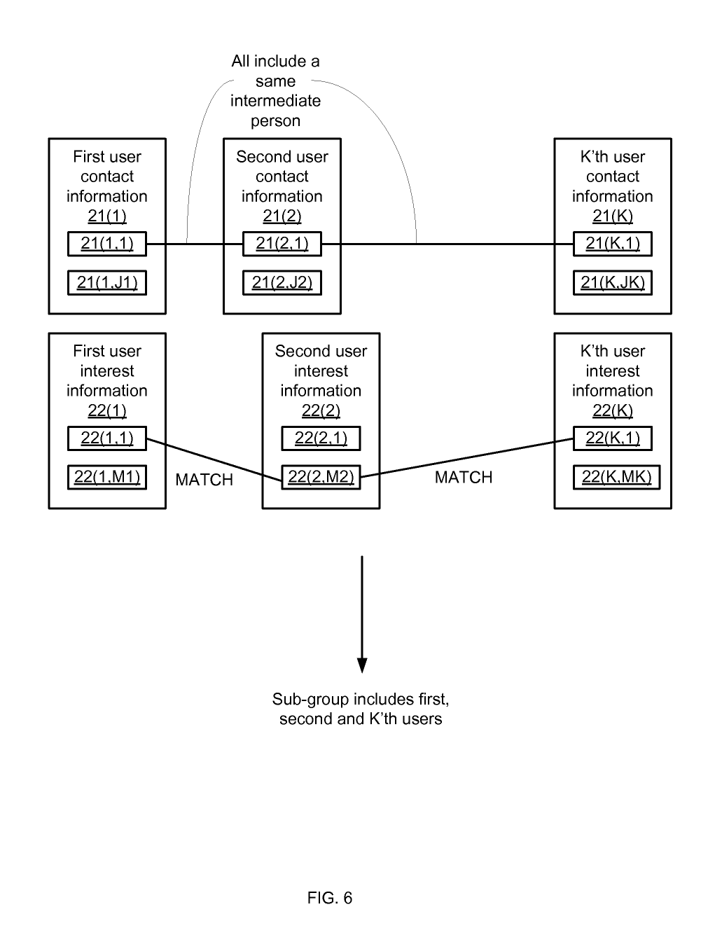

FIG. 6 illustrates metadata 20(1), 20(2) and 20(K) of a sub-group of users according to an embodiment of the invention.

First, second and K'th users are included in the sub-group because they are connected to the same intermediate person (represented by contact information 21(1,1) of first user, by content information 21(2,1) of second user and by contact information 21(K,1) of the K'th user) AND have matching interests (interests are represented by interest information 22(1,1) of first user, 22(2,M2) of second user and 22(K,1) of K'th user).

Referring back to FIG. 1—stage 120 may be followed by stage 130 of responding to the finding of the sub-groups of users.

The responding (stage 130) may include at least one out of:
a. Providing to the users of the sub-group of users an indication that they belong to the sub-group of users.
b. Providing to the users of the sub-group of users matching indications about the matching interests and/or contact information for allowing the users of the sub-group to contact each other.
c. Sending an indication to the intermediate person.
d. Preventing from interacting with the intermediate person.
e. Assisting in fulfilling the matching interest.

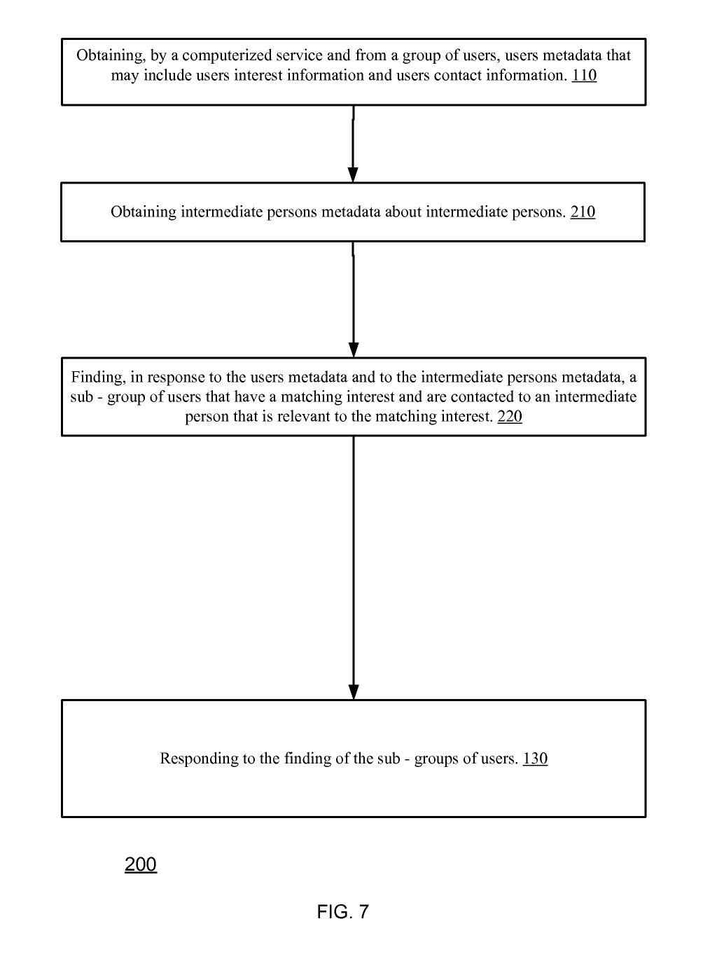

FIG. 7 illustrates method 200 according to an embodiment of the invention.

Method 200 may start by stage 110.

Stage 110 may include obtaining, by a computerized service and from a group of users, users metadata that may include users interest information and users contact information.

Stage 110 may be followed by stage 210.

Stage 210 may include obtaining intermediate persons metadata about intermediate persons. Intermediate persons may be persons that are listed in the contact information of users of the group of users. Intermediate persons may be persons that are estimated by the computerized system to be linked to the users of the group of users even if not listed in their contact information.

Stages 210 may be followed by stage 220.

Stage 220 may include finding, in response to the users metadata and to the intermediate persons metadata, a sub-group of users that have a matching interest and are contacted to an intermediate person that is relevant to the matching interest.

The intermediate person may be relevant if, for example, he has a field of interest (occupation, hobby) that is relevant to the matching interest. Yet for example a male user may be excluded from being used as an intermediate person for a purchase of female hygiene products.

Stage 220 may be followed by stage 130 of responding to the finding of the sub-groups of users.

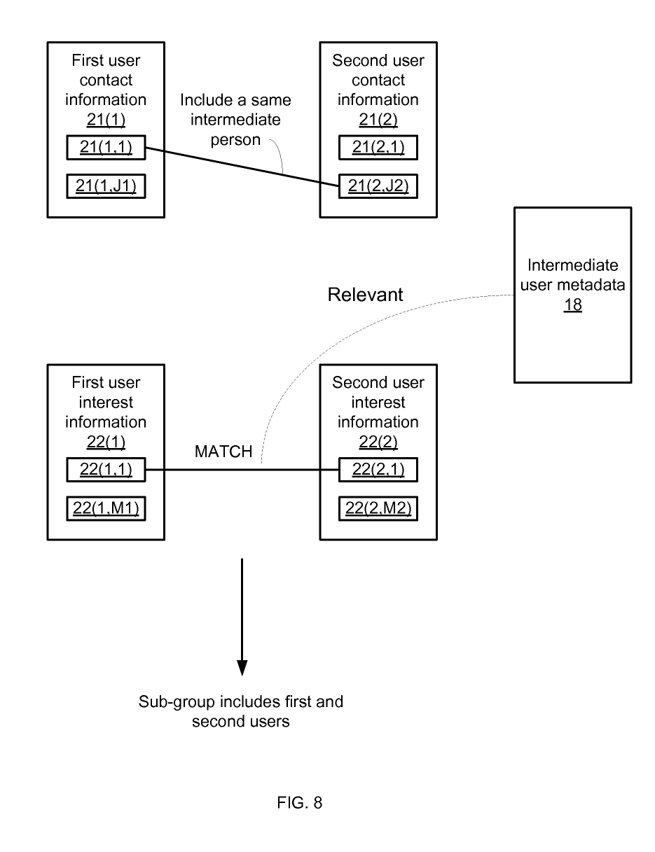

FIG. 8 illustrates metadata 20(1) and 20(2) of a sub-group of users and intermediate person metadata 18 according to an embodiment of the invention.

First and second users are included in the sub-group because they have matching interests (interests are represented by interest information 22(1,1) of first user and 22(2,2) of second user), they are connected to the same intermediate person (represented by contact information 21(1,1) of first user and by content information 21(2,J2) of second user) AND the intermediate user is relevant to the matching interest.

The invention may also be implemented in a computer program for running on a computer system, at least including code portions for performing steps of a method according to the invention when run on a programmable apparatus, such as a computer system or enabling a programmable apparatus to perform functions of a device or system according to the invention. The computer program may cause the storage system to allocate disk drives to disk drive groups.

A computer program is a list of instructions such as a particular application program and/or an operating system. The computer program may for instance include one or more of: a subroutine, a function, a procedure, an object method, an object implementation, an executable application, an applet, a servlet, a source code, an object code, a shared library/dynamic load library and/or other sequence of instructions designed for execution on a computer system.

The computer program may be stored internally on a non-transitory computer readable medium. All or some of the computer program may be provided on computer readable media permanently, removably or remotely coupled to an information processing system. The computer readable media may include, for example and without limitation, any number of the following: magnetic storage media including disk and tape storage media; optical storage media such as compact disk media (e.g., CD-ROM, CD-R, etc.) and digital video disk storage media; nonvolatile memory storage media including semiconductor—based memory units such as FLASH memory, EEPROM, EPROM, ROM; ferromagnetic digital memories; MRAM; volatile storage media including registers, buffers or caches, main memory, RAM, etc.

A computer process typically includes an executing (running) program or portion of a program, current program values and state information, and the resources used by the operating system to manage the execution of the process. An operating system (OS) is the software that manages the sharing of the resources of a computer and provides programmers with an interface used to access those resources. An operating system processes system data and user input, and responds by allocating and managing tasks and internal system resources as a service to users and programs of the system.

The computer system may for instance include at least one processing unit, associated memory and a number of input/output (I/O) devices. When executing the computer program, the computer system processes information according to the computer program and produces resultant output information via I/O devices.

In the foregoing specification, the invention has been described with reference to specific examples of embodiments of the invention. It will, however, be evident that various modifications and changes may be made therein without departing from the broader spirit and scope of the invention as set forth in the appended claims.

Moreover, the terms “front,” “back,” “top,” “bottom,” “over,” “under” and the like in the description and in the claims, if any, are used for descriptive purposes and not necessarily for describing permanent relative positions. It is understood that the terms so used are interchangeable under appropriate circumstances such that the embodiments of the invention described herein are, for example, capable of operation in other orientations than those illustrated or otherwise described herein.

The connections as discussed herein may be any type of connection suitable to transfer signals from or to the respective nodes, units or devices, for example via intermediate devices. Accordingly, unless implied or stated otherwise, the connections may for example be direct connections or indirect connections. The connections may be illustrated or described in reference to being a single connection, a plurality of connections, unidirectional connections, or bidirectional connections. However, different embodiments may vary the implementation of the connections. For example, separate unidirectional connections may be used rather than bidirectional connections and vice versa. Also, plurality of connections may be replaced with a single connection that transfers multiple signals serially or in a time multiplexed manner. Likewise, single connections carrying multiple signals may be separated out into various different connections carrying subsets of these signals. Therefore, many options exist for transferring signals.

Although specific conductivity types or polarity of potentials have been described in the examples, it will be appreciated that conductivity types and polarities of potentials may be reversed.

Each signal described herein may be designed as positive or negative logic. In the case of a negative logic signal, the signal is active low where the logically true state corresponds to a logic level zero. In the case of a positive logic signal, the signal is active high where the logically true state corresponds to a logic level one. Note that any of the signals described herein may be designed as either negative or positive logic signals. Therefore, in alternate embodiments, those signals described as positive logic signals may be implemented as negative logic signals, and those signals described as negative logic signals may be implemented as positive logic signals.

Furthermore, the terms “assert” or “set” and “negate” (or “deassert” or “clear”) are used herein when referring to the rendering of a signal, status bit, or similar apparatus into its logically true or logically false state, respectively. If the logically true state is a logic level one, the logically false state is a logic level zero. And if the logically true state is a logic level zero, the logically false state is a logic level one.

Those skilled in the art will recognize that the boundaries between logic blocks are merely illustrative and that alternative embodiments may merge logic blocks or circuit elements or impose an alternate decomposition of functionality upon various logic blocks or circuit elements. Thus, it is to be understood that the architectures depicted herein are merely exemplary, and that in fact many other architectures may be implemented which achieve the same functionality.

Any arrangement of components to achieve the same functionality is effectively “associated” such that the desired functionality is achieved. Hence, any two components herein combined to achieve a particular functionality may be seen as “associated with” each other such that the desired functionality is achieved, irrespective of architectures or intermedial components. Likewise, any two components so associated can also be viewed as being “operably connected,” or “operably coupled,” to each other to achieve the desired functionality.

Furthermore, those skilled in the art will recognize that boundaries between the above described operations merely illustrative. The multiple operations may be combined into a single operation, a single operation may be distributed in additional operations and operations may be executed at least partially overlapping in time. Moreover, alternative embodiments may include multiple instances of a particular operation, and the order of operations may be altered in various other embodiments.

Also for example, in one embodiment, the illustrated examples may be implemented as circuitry located on a single integrated circuit or within a same device. Alternatively, the examples may be implemented as any number of separate integrated circuits or separate devices interconnected with each other in a suitable manner.

Also for example, the examples, or portions thereof, may implemented as soft or code representations of physical circuitry or of logical representations convertible into physical circuitry, such as in a hardware description language of any appropriate type.

Also, the invention is not limited to physical devices or units implemented in non-programmable hardware but can also be applied in programmable devices or units able to perform the desired device functions by operating in accordance with suitable program code, such as mainframes, minicomputers, servers, workstations, personal computers, notepads, personal digital assistants, electronic games, automotive and other embedded systems, cell phones and various other wireless devices, commonly denoted in this application as ‘computer systems’.

However, other modifications, variations and alternatives are also possible. The specifications and drawings are, accordingly, to be regarded in an illustrative rather than in a restrictive sense.

In the claims, any reference signs placed between parentheses shall not be construed as limiting the claim. The word ‘comprising’ does not exclude the presence of other elements or steps then those listed in a claim. Furthermore, the terms “a” or “an,” as used herein, are defined as one or more than one. Also, the use of introductory phrases such as “at least one” and “one or more” in the claims should not be construed to imply that the introduction of another claim element by the indefinite articles “a” or “an” limits any particular claim containing such introduced claim element to inventions containing only one such element, even when the same claim includes the introductory phrases “one or more” or “at least one” and indefinite articles such as “a” or “an.” The same holds true for the use of definite articles. Unless stated otherwise, terms such as “first” and “second” are used to arbitrarily distinguish between the elements such terms describe. Thus, these terms are not necessarily intended to indicate temporal or other prioritization of such elements. The mere fact that certain measures are recited in mutually different claims does not indicate that a combination of these measures cannot be used to advantage.

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

We claim:

1. A method for matching between interests of different users, the method comprises:
obtaining, by a computerized service and from a group of users, users metadata that comprises users interest information and users contact information; wherein the obtaining of the users metadata involves an interaction between each user of the group of users and the computerized service;
finding, in response to the users metadata, a sub-group of users that have a matching interest and are contacted to an intermediate person; wherein the finding of the sub-group of users is executed without receiving an input from the intermediate person; and
responding to the finding of the sub-groups of users.

2. The method according to claim 1 wherein the intermediate person is not registered to the computerized service.

3. The method according to claim 1 wherein the intermediate person does not belong to the group of users.

4. The method according to claim 1 wherein the responding to the finding of the sub-groups of users does not involve any interaction with the intermediate person.

5. The method according to claim 1 wherein the obtaining of the users metadata comprises providing to the computerized service and by each user of the group of users at least a portion of a user metadata associated with the user.

6. The method according to claim 1 wherein the responding to the finding of the sub-groups of users comprises sending to the sub-group of users a matching indication.

7. The method according to claim 1 further comprising preventing from sending the intermediate person the matching indication.

8. The method according to claim 1 further comprising sending the intermediate person the matching indication.

9. The method according to claim 1 wherein the processing of the user metadata comprises correlating between user contact information of different formats.

10. The method according to claim 1 wherein the processing of the user metadata comprises generating user profiles of users listed in the users contact information; wherein a generation of a user profile comprises accumulating user contact information from different formats of user contact information.

11. The method according to claim 1 wherein the processing of the user metadata comprises generating user profiles of users listed in the users contact information; wherein a generation of a user profile comprises fetching user contact information that is not included in the users contact information.

12. The method according to claim 1 wherein the obtaining of the users contact information comprising retrieving users contact information from social networks and electronic mail services of the users.

13. The method according to claim 1 wherein the obtaining of the users metadata comprises displaying to the users forms and receiving from the users inputs to the forms.

14. The method according to claim 13 further comprising generating the forms.

15. The method according to claim 13 further comprising receiving the forms.

16. The method according to claim 1 further comprising retrieving intermediate person metadata; and finding the sub-group of users only if the person is relevant to the matching interest.

17. A method for matching between interests of different users, the method comprises:
obtaining, by a computerized system and from a group of users that are registered to a computerized service, users metadata that comprises users interest information and users contact information;
finding, in response to the users metadata, a sub-group of users that have a matching interest and are contacted to an intermediate person that is not registered to the computerized service; and
responding to the finding of the sub-groups of users

18. A method for matching between interests of different users, the method comprises:
obtaining, by a computerized system and from a group of users that are registered to a computerized service, users metadata that comprises users interest information and users contact information;
finding, in response to the users metadata, a sub-group of users that have a matching interest and are contacted to an intermediate person that is not registered to the computerized service and is relevant to the matching interest; and
responding to the finding of the sub-groups of users.

19. A non-transitory computer readable medium that stores instructions that once executed by a computer cause the computer to execute the stages of: obtaining, by a computerized system and from a group of users that are registered to a computerized service, users metadata that comprises users interest information and users contact information; processing the users metadata to find a sub-groups of users that have a matching interest and are contacted to an intermediate person that is not registered to the computerized service; and responding to the finding of the sub-groups of users.
